(19) United States
(12) Patent Application Publication
(10) Pub. No.: US 2025/0039789 A1
(43) Pub. Date: Jan. 30, 2025

(54) TRANSMISSION WINDOWS FOR PEER-TO-PEER COMMUNICATIONS

(71) Applicant: Samsung Electronics Co., Ltd., Suwon-si (KR)

(72) Inventors: Rubayet Shafin, Allen, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/757,229

(22) Filed: Jun. 27, 2024

Related U.S. Application Data
(60) Provisional application No. 63/528,844, filed on Jul. 25, 2023.

(51) Int. Cl. H04W 52/02

(52) U.S. Cl. CPC H04W 52/0225

(57) ABSTRACT

Methods and apparatuses for facilitating establishment of a common power saving schedule for multiple peer-to-peer (P2P) devices in a wireless local area network (WLAN). A first peer station device (STA) comprises a transceiver and a processor operably connected to the transceiver. The transceiver is configured to communicate over P2P links with one or more other peer STAs. The processor is configured to determine parameters of a P2P power saving schedule. The transceiver is further configured to transmit, to the one or more other peer STAs, a message including information on the parameters of the P2P power saving schedule.

### CROSS-REFERENCE TO RELATED APPLICATION AND CLAIM OF PRIORITY

This application claims priority under 35 U.S.C. § 119(e) to U.S. Provisional Patent Application No. 63/528,844 filed on Jul. 25, 2023, which is hereby incorporated by reference in its entirety.

### TECHNICAL FIELD

This disclosure relates generally to power saving operations in wireless communications systems. Embodiments of this disclosure relate to methods and apparatuses that facilitate establishing a common power sharing schedule for multiple peer-to-peer devices in a wireless local area network communications system.

### BACKGROUND

Wireless local area network (WLAN) technology allows devices to access the internet in the 2.4 gigahertz (GHz), 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

Target wake time (TWT) is one of the most important features for power management in WI-FI networks, which was developed by IEEE 802.11ah and later adopted and modified into IEEE 802.11ax. TWT allows an AP to manage activity in the BSS (basic service set) to minimize contention between STAs and reduce the required amount of time that a STA utilizing a power management mode needs to be awake. This is achieved by allocating STAs to operate at nonoverlapping times and/or frequencies and concentrating the frame exchange sequences in predefined service periods. With TWT operation, it suffices for a STA to only wake up at a pre-scheduled time negotiated with another STA or AP in the network. A STA does not need to be aware of the values of TWT parameters of the TWT agreements of other STAs in the BSS of the STA or of TWT agreements of STAs in other BSSs. A STA does not need to be aware that a TWT service period (SP) is used to exchange frames with other STAs. Frames transmitted during a TWT SP are carried in any PPDU format supported by the pair of STAs that have established the TWT agreement corresponding to that TWT SP, including HE MU PPDU, HE TB PPDU, etc.

In IEEE 802.11 standards, two types of TWT operation are possible—individual TWT operation and broadcast TWT operation. Individual TWT agreements can be established between two STAs or between a STA and an AP. The negotiation that takes place for an individual TWT agreement between two STAs is on an individual basis. The AP can have TWT agreements with multiple STAs. Any changes in the TWT agreement between the AP and one STA do not affect the TWT agreement between the AP and the other STA.

IEEE 802.11ax first introduced the broadcast TWT (bTWT or B-TWT) operation. The broadcast TWT operates in a membership-based approach. With broadcast TWT operation, an AP can set up a shared TWT session for a group of STAs. The AP is typically the controller of the broadcast TWT schedule. The non-AP STAs in the BSS can request membership in the schedule, or the AP can send an unsolicited response to the STA to make the STA a member of the broadcast TWT schedule the AP maintains in the BSS. The AP can advertise/announce and maintain multiple broadcast TWT schedules in the network. When a change is made to any of the schedules in the network, it affects all the STAs that are members of that particular schedule.

Restricted TWT (rTWT or R-TWT) operation is another key feature introduced in IEEE 802.11be standards with a view to providing better support for latency-sensitive applications. Restricted TWT offers a protected service period for its member STAs by sending Quiet elements to other STAs in the BSS which are not members of the rTWT schedule, where the Quiet interval corresponding to the Quiet element overlaps with the initial portion of the restricted TWT SP. Hence, it gives more channel access opportunity for the rTWT member scheduled STAs, which definitely helps latency-sensitive traffic flow.

TWT enhancements for multi-link devices have been introduced in the IEEE 802.11be specification. For individual TWT agreements between two MLDs, a STA affiliated with an MLD, which is a TWT requesting STA, may indicate the link(s) that are requested for setting up TWT agreement(s) in the Link ID Bitmap subfield, if present, of a TWT element in the TWT request. If only one link is indicated in the Link ID Bitmap subfield of the TWT element, then a single TWT agreement is requested for the STA affiliated with the same MLD, which is operating on the indicated link. The Target Wake Time field of the TWT element shall be in reference to the TSF time of the link indicated by the TWT element. A TWT responding STA affiliated with a peer MLD that receives a TWT request that contains a Link ID Bitmap subfield in a TWT element shall respond with a TWT response that indicates the link(s) in the Link ID Bitmap field of a TWT element. The link(s), if present, in the TWT element carried in the TWT response shall be the same as the link(s) indicated in the TWT element of the soliciting TWT request.

Interference from one BSS often causes performance issues for STAs and APs in nearby BSSs. This naturally results in overall throughput degradation in the network. The Overlapping BSS (OBSS) interference can also increase the overall latency since it takes more time to access the channel due to the interference occupying the channel. If a STA in a BSS has latency-sensitive traffic, this delay in channel access can seriously hamper the STA's latency-sensitive applications. TWT-based Multi-AP coordination can be an important feature for next-generation WLAN networks.

### SUMMARY

Embodiments of the present disclosure provide methods and apparatuses that facilitate establishment of a common power saving schedule for multiple peer-to-peer (P2P) devices in a WLAN.

In one embodiment, a first peer STA comprises a transceiver and a processor operably connected to the transceiver. The transceiver is configured to communicate over P2P links with one or more other peer STAs. The processor is configured to determine parameters of a P2P power saving schedule. The transceiver is further configured to transmit, to the one or more other peer STAs, a message including information on the parameters of the P2P power saving schedule.

In another embodiment, a method performed by a first peer STA comprises communicating over P2P links with one or more other peer STAs, determining parameters of a P2P power saving schedule, and transmitting, to the one or more other peer STAs, a message including information on the parameters of the P2P power saving schedule.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example network architecture in which infrastructure traffic and non-infrastructure traffic coexist according to embodiments of the present disclosure;

FIG. 4 illustrates an example network configuration including a P2P scheduling STA and P2P scheduled STAs according to embodiments of the present disclosure;

FIG. 5A illustrates an example network configuration including a P2P scheduling STA and P2P scheduled STAs according to embodiments of the present disclosure;

FIG. 5B illustrates an example timing diagram of the awake states of the P2P scheduled STAs in the example network configuration according to embodiments of the present disclosure;

FIG. 5C illustrates an example timing diagram of communication between the P2P scheduling STA and the P2P scheduled STAs in the example network configuration according to embodiments of the present disclosure;

FIG. 6 illustrates an example network configuration including a P2P scheduling STA and P2P scheduled STAs according to embodiments of the present disclosure;

FIG. 7A illustrates an example network configuration including a P2P scheduling STA and P2P scheduled STAs according to embodiments of the present disclosure;

FIG. 7B illustrates an example timing diagram of communication between the P2P scheduled STAs in the example network configuration according to embodiments of the present disclosure;

FIG. 8 illustrates an example timing diagram of a negotiation for membership in a P2P schedule according to embodiments of the present disclosure; and

FIG. 9 illustrates an example process for facilitating establishment of a common power saving schedule for multiple P2P devices in a WLAN according to various embodiments of the present disclosure.

### DETAILED DESCRIPTION

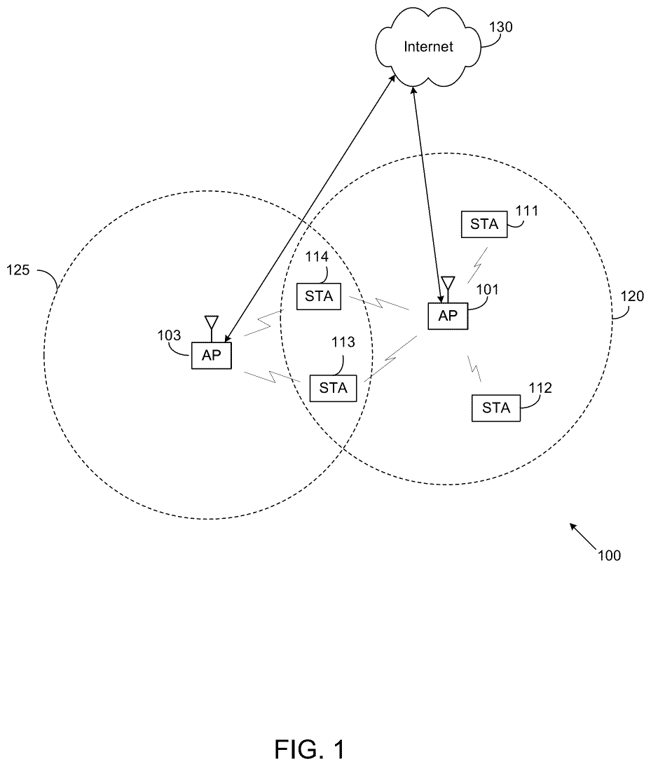

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that next generation WLAN systems will need to provide strong support for low-latency (i.e., latency-sensitive) applications. It is not uncommon to observe numerous devices operating on the same network (e.g., the same BSS). Many such devices may be latency-tolerant but still contend with devices with latency-sensitive applications for the same time and frequency resources in the BSS. In some cases, the AP as the network controller of an infrastructure BSS may not have enough control over unregulated (or unmanaged) traffic that contends with the latency-sensitive traffic within the infrastructure BSS. Some of the unmanaged traffic that interferes with the latency-sensitive traffic in the AP's BSS may come from uplink (UL)/downlink (DL) or direct link (e.g., peer-to-peer or P2P) communications within the infrastructure BSS that the AP manages (i.e., infrastructure traffic). Other unmanaged traffic interference may come from transmissions in a neighboring infrastructure BSS (an overlapping BSS, or OBSS). Yet other unmanaged traffic interference may come from neighboring independent BSSs or P2P networks.

Embodiments of the present disclosure thus recognize that next generation WLAN systems will need mechanisms to handle unmanaged traffic in order to prioritize the low-latency traffic in the network. For a WLAN network, if the STAs within the BSS or neighboring BSSs use pre-determined or recommended channels for uplink/downlink or direct link communications, this could significantly help to manage the traffic in the BSS, and thereby support latency-sensitive applications in the network.

Embodiments of the present disclosure further recognize that two WI-FI peer STAs (e.g., tunneled direct link setup (TDLS) peer STAs, WI-FI AWARE neighbor awareness networking (NAN) peer STAs, WI-FI DIRECT peer STAs) can set up power-saving (PS) mechanisms between themselves. For convenience, embodiments of the present disclosure may refer to TDLS, but it is understood that any suitable WI-FI P2P mechanism may be used in place of TDLS.

The P2P PS mechanisms include individual TWT, TDLS peer PSM, and TDLS U-APSD. When the number of TDLS peer STAs increases in the network, the number of different PS schedules also increases. Essentially, a STA that has set up TDLS direct links with multiple other STAs may need to maintain and wake up at different times corresponding to those separate schedules—this may not be very efficient for the peer STAs and may cause them to consume significant power.

Accordingly, embodiments of the present disclosure provide mechanisms for a P2P peer STA to use a single P2P PS schedule to communicate with multiple STAs. In particular, the present disclosure provides methods and apparatuses that facilitate establishing a common PS schedule for multiple peer STAs. As noted above, the disclosure is applicable for peer STAs that follow the TDLS mechanism or other P2P mechanisms.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

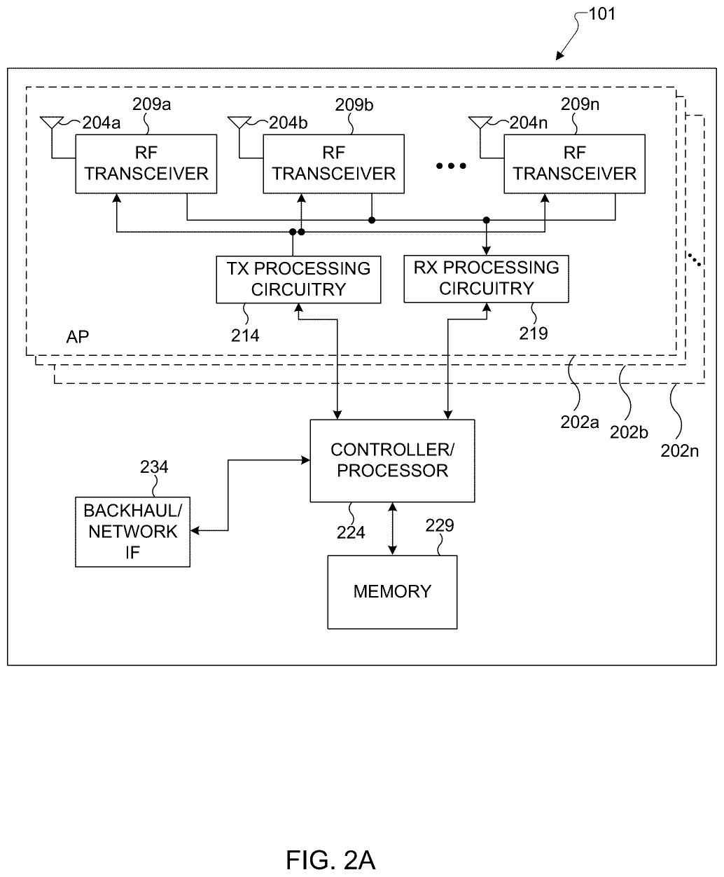

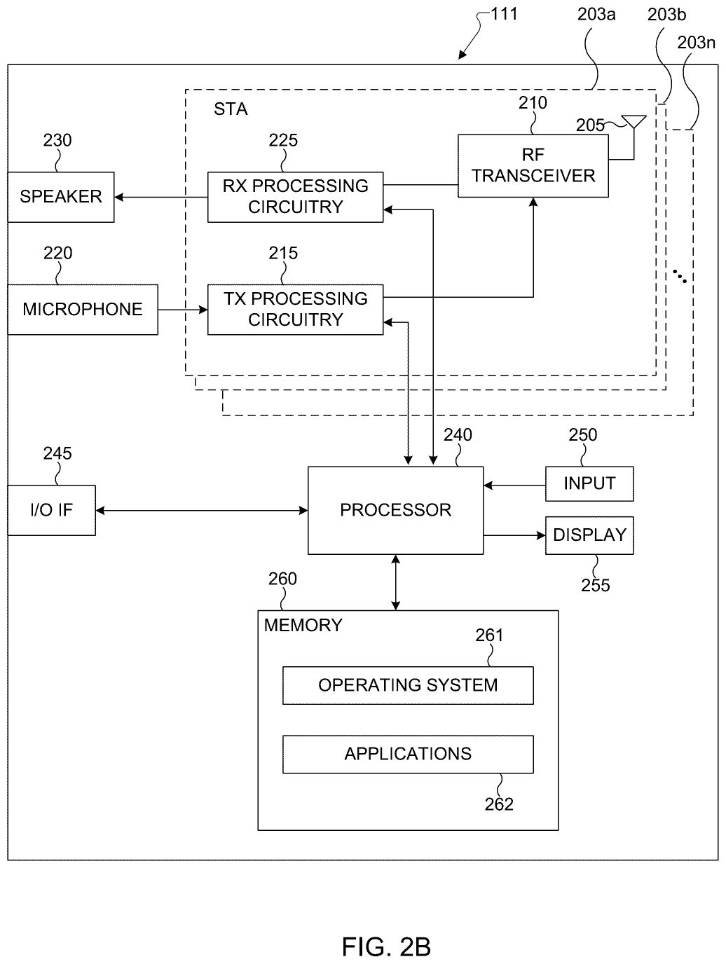

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). The controller/processor 224 could also facilitate establishment of a common power saving schedule for multiple P2P devices in a WLAN. Any of a wide variety of other functions could be supported in the AP MLD 101 by the controller/processor 224. In some embodiments, the controller/processor 224 includes at least one microprocessor or microcontroller. The controller/processor 224 is also capable of executing programs and other processes resident in the memory 229, such as operations for facilitating establishment of a common power saving schedule for multiple P2P devices in a WLAN. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate establishment of a common power saving schedule for multiple P2P devices in a WLAN. In some embodiments, the controller/processor 240 includes at least one microprocessor or microcontroller.

The controller/processor 240 is also capable of executing other processes and programs resident in the memory 260, such as operations for facilitating establishment of a common power saving schedule for multiple P2P devices in a WLAN. The controller/processor 240 can move data into or out of the memory 260 as required by an executing process. In some embodiments, the controller/processor 240 is configured to execute a plurality of applications 262, such as applications for facilitating establishment of a common power saving schedule for multiple P2P devices in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

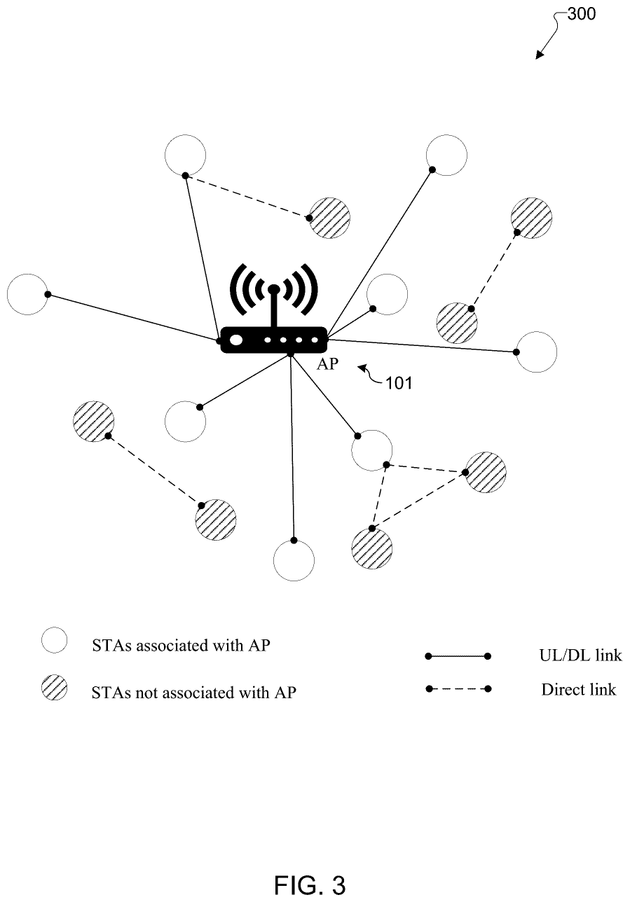

FIG. 3 illustrates an example network architecture 300 in which infrastructure traffic and non-infrastructure traffic coexist according to embodiments of the present disclosure. In the example of FIG. 3, the AP may be an AP 101, and each of the STAs may be a STA 111-114, although not all of the STAs are associated with the AP. The STAs that are not associated with the AP may belong to P2P networks. It is understood that references to an AP herein below refer to an AP 101 (or AP MLD 101), and references to a non-AP STA refer to a STA 111-114 (or non-AP MLD 111-114).

As discussed above, various embodiments of the present disclosure provide methods and apparatuses that facilitate establishment of a common power saving schedule for multiple P2P devices in a WLAN. According to one embodiment, a first TDLS peer STA can assume the role of a broadcast TWT scheduling AP and advertise a P2P PS schedule (e.g., a TWT schedule) to other TDLS peer STAs. A second TDLS peer STA can assume the role of a broadcast TWT scheduled STA and seek and obtain membership in the TWT schedule advertised by the first TDLS peer STA. The first TDLS peer STA can be referred to as a P2P scheduling STA. The second TDLS peer STA can be referred to as a P2P scheduled STA. The TWT schedule can be referred to as a P2P schedule.

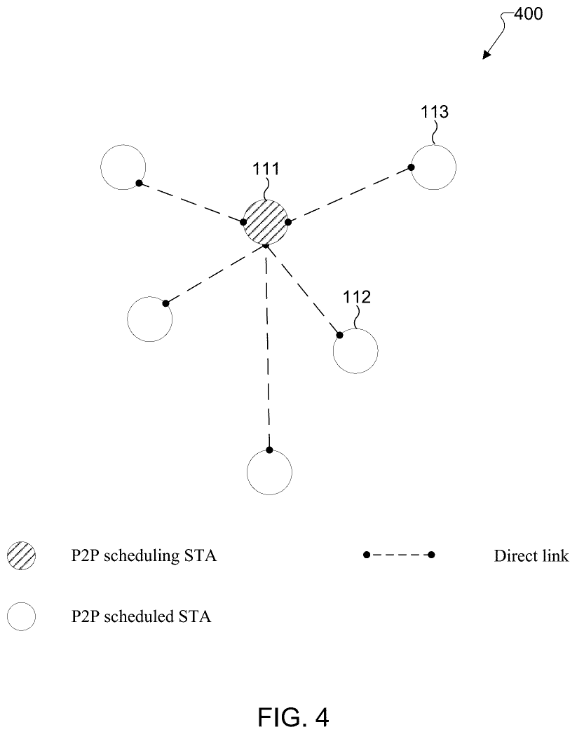

FIG. 4 illustrates an example network configuration 400 including a P2P scheduling STA and P2P scheduled STAs according to embodiments of the present disclosure. In this example, a number of P2P scheduled STAs have P2P links (e.g., TDLS direct links) formed with the P2P scheduling STA.

According to one embodiment, when a first TDLS peer STA advertises a TWT or P2P schedule (e.g., when a first TDLS peer STA is a P2P scheduling STA), then the first peer STA is expected to be awake during the TWT SPs (or P2P SPs) corresponding to the P2P schedule. According to one embodiment, when a second TDLS peer STA obtains membership in the P2P schedule (e.g., when a second TDLS peer STA is a P2P scheduled STA), then the second peer STA is expected to be awake during the TWT SPs (or P2P SPs) corresponding to the P2P schedule.

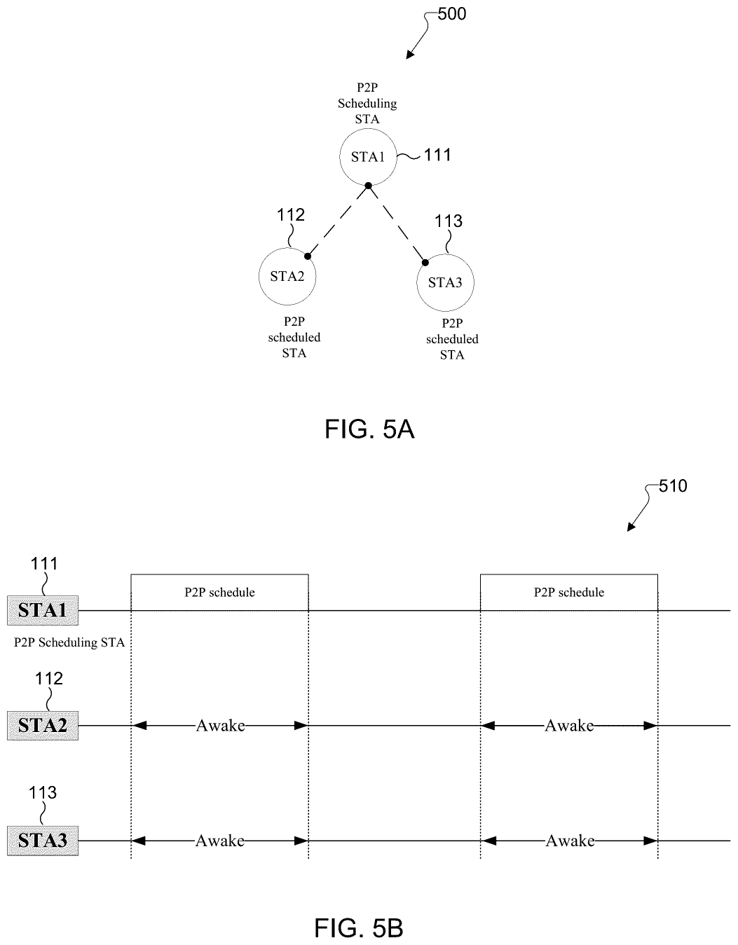

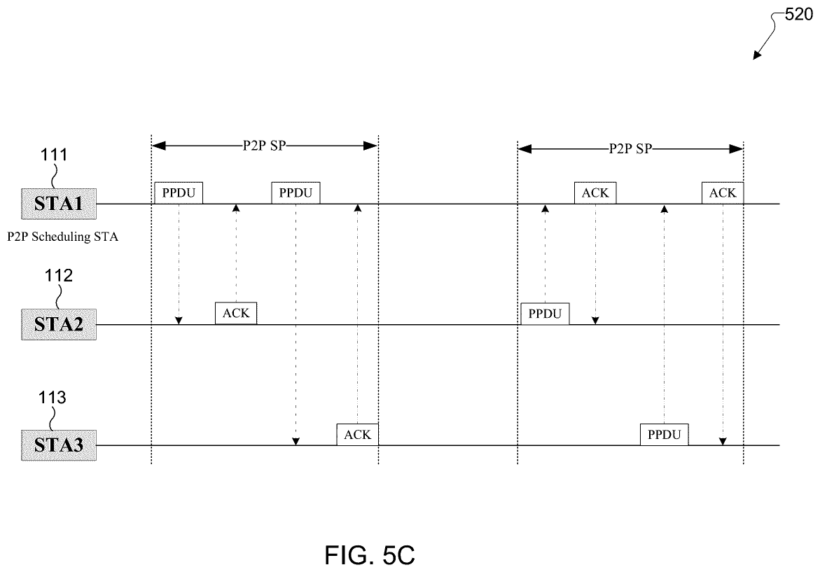

FIG. 5A illustrates an example network configuration 500 including a P2P scheduling STA and P2P scheduled STAs according to embodiments of the present disclosure. In this example, the P2P scheduled STAs 112 and 113 are members of the P2P schedule advertised by the P2P scheduling STA 111.

FIG. 5B illustrates an example timing diagram 510 of the awake states of the P2P scheduled STAs in the example network configuration 500 according to embodiments of the present disclosure. As illustrated in this example, the P2P scheduled STAs 112 and 113 remain awake during the P2P SPs of the P2P schedule.

According to one embodiment, when a first TDLS peer STA advertises a TWT or P2P schedule (e.g., when a first TDLS peer STA is a P2P scheduling STA), and a second TDLS peer STA obtains membership in that schedule (e.g., when a second TDLS peer STA is a P2P scheduled STA), then the first peer STA and the second peer STA can communicate between themselves during the P2P SPs.

FIG. 5C illustrates an example timing diagram 520 of communication between the P2P scheduling STA and the P2P scheduled STAs in the example network configuration 500 according to embodiments of the present disclosure. As illustrated in this example, the P2P scheduling STA 111 may communicate over the P2P direct link with P2P scheduled STAs 112 and 113 during the P2P SPs of the P2P schedule.

According to one embodiment, when a first TDLS peer STA advertises a TWT or P2P schedule (e.g., when a first TDLS peer STA is a P2P scheduling STA), and a second peer STA and a third peer STA obtain membership in that schedule (e.g., when a second TDLS peer STA and a third TDLS peer STA are P2P scheduled STAs), then the second peer STA and the third peer STA can communicate between themselves during the P2P SPs of the P2P schedule. In such embodiments, the second peer STA and the third peer STA may have established a TDLS direct link between themselves a priori.

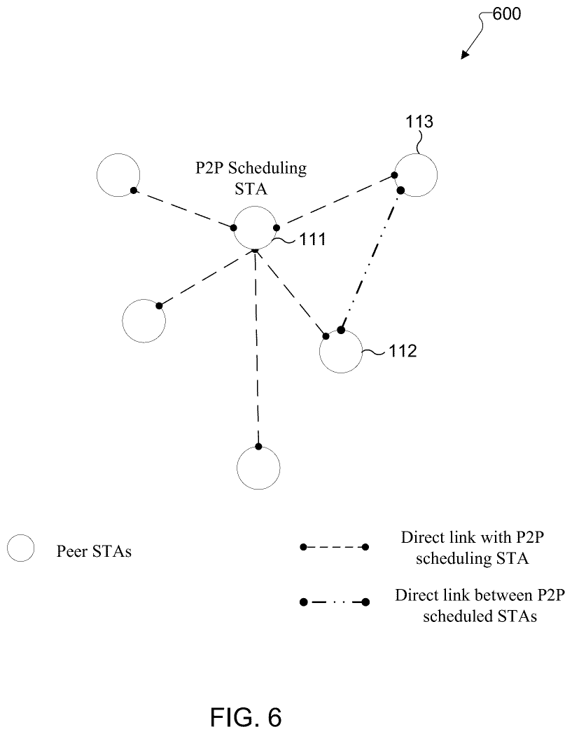

FIG. 6 illustrates an example network configuration 600 including a P2P scheduling STA and P2P scheduled STAs according to embodiments of the present disclosure. In this example, a number of P2P scheduled STAs have P2P links (e.g., TDLS direct links) formed with the P2P scheduling STA. Additionally, the P2P scheduled STAs 112 and 113 have formed a P2P link between themselves.

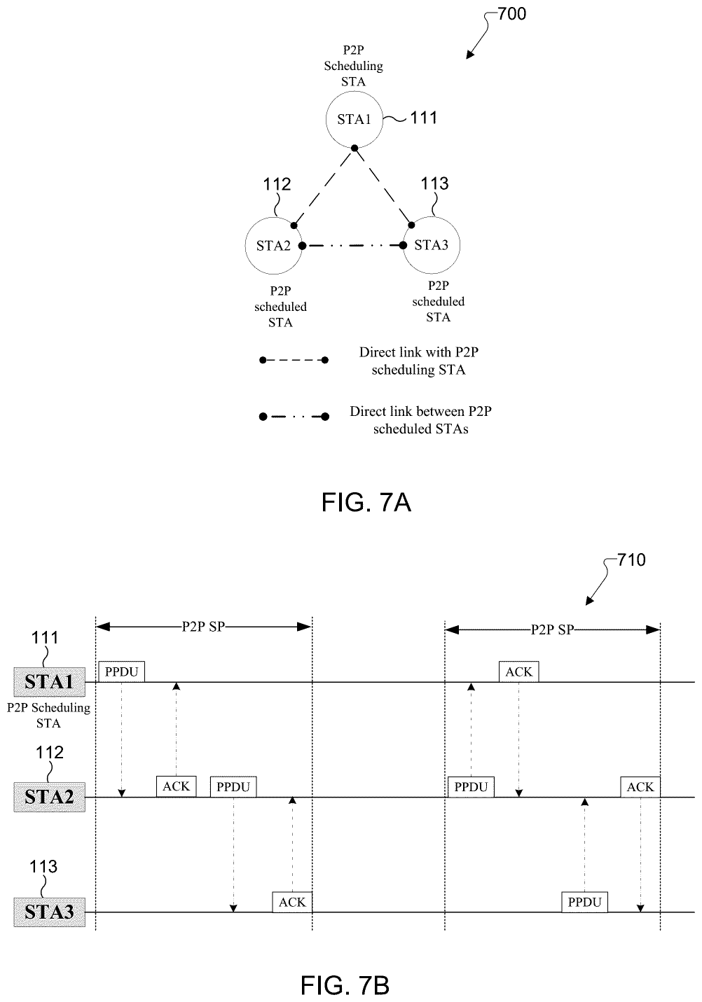

FIG. 7A illustrates an example network configuration 700 including a P2P scheduling STA and P2P scheduled STAs according to embodiments of the present disclosure. In this example, the P2P scheduled STAs 112 and 113 are members of the P2P schedule advertised by the P2P scheduling STA 111, and have established a P2P link between themselves.

FIG. 7B illustrates an example timing diagram 710 of communication between the P2P scheduled STAs in the example network configuration 700 according to embodiments of the present disclosure. As illustrated in this example, the P2P scheduled STAs 112 and 113 may communicate with each other over their P2P direct link as well as with the P2P scheduling STA 111 over the corresponding P2P direct link during the P2P SPs of the P2P schedule.

According to one embodiment, a first TDLS peer STA (e.g., a P2P scheduling STA) can transmit beacon frames in a periodic manner. Such a beacon frame can be referred to as a P2P beacon frame. The P2P beacon frame can contain information similar to the beacon frame transmitted by an infrastructure AP. The P2P beacon frame can contain information about a P2P schedule that is being advertised to other peer STAs so that the other peer STAs may obtain membership in the P2P schedule.

According to one embodiment, when a first TDLS peer STA (e.g., a P2P scheduling STA) advertises a TWT or P2P schedule, a second TDLS peer STA that has established a TDLS direct link with the first STA can request membership in the P2P schedule. The first peer STA, upon receiving the request, may respond to the second peer STA with either an ACCEPT or REJECT response.

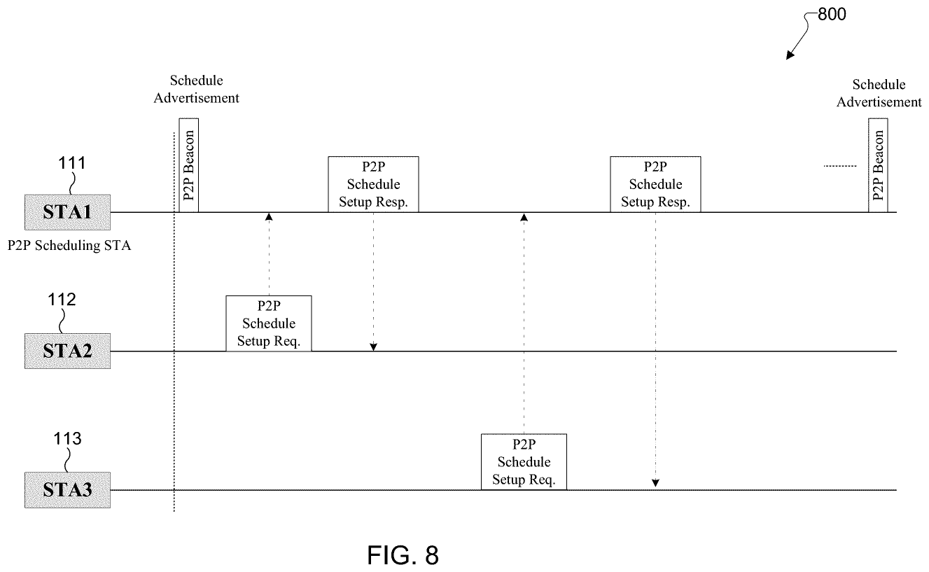

FIG. 8 illustrates an example timing diagram 800 of a negotiation for membership in a P2P schedule according to embodiments of the present disclosure. In this example, the P2P scheduling STA 111 transmits periodic P2P Beacon frames that advertise a P2P schedule (e.g., by inclusion of parameters of the P2P schedule). The P2P scheduled STAs 112 and 113 receive a P2P Beacon frame and send P2P Schedule Setup Request frames to request membership in the P2P schedule corresponding to the P2P Beacon frame. The P2P scheduling STA 111 receives the P2P Schedule Setup Request frames, determines whether to accept or reject the corresponding request, and transmits corresponding P2P Schedule Setup Response frames to the P2P scheduled STAs 112 and 113 with either an ACCEPT or REJECT response.

According to one embodiment, the peer STA that will act as the P2P scheduling STA can be determined from among a group of peer STAs using a distributed algorithm. The algorithm for determining which peer STA will act as the P2P scheduling STA can be similar to the algorithm used in the WI-FI AWARE specification for deciding the NAN Master device from among the group of NAN devices. For example, in the WI-FI AWARE NAN master selection process, at the start of formation of a NAN device group all participating NAN devices broadcast their respective priority levels for becoming the NAN master device. Based on the priority levels declared, the NAN device that has the highest priority level for a given session becomes the NAN master device.

Tight coordination with the infrastructure network (e.g., the UL/DL network) would be desirable for better manageability of the P2P networks. According to one embodiment, a P2P scheduling STA can inform its associated AP about the P2P schedule (and seek assistance). The P2P scheduling STA can indicate the number of members of the P2P schedule or provide a list of association identifiers (AIDs) of the peer STAs that are members of the P2P schedule to assist the AP in resource provisioning for the P2P schedule. Instead of AID information, the MAC addresses of the peer STAs that are members of the P2P schedule can also be shared with the AP to identify the peer STAs that have become members of the P2P schedule. In the case in which no information on an AID list or MAC address list are provided, the AP may still allocate resources based on the general P2P schedule information such as the number of peer STAs in the schedule, etc. The AP can simply trigger on a per-P2P cluster/schedule basis.

According to one embodiment, the AP can send a variant of the transmission opportunity (TXOP) sharing (TXS) Trigger frame during the P2P SP to allocate a TXOP to a peer STA so that the peer STA can use the TXOP for its own transmissions. The trigger frame would be P2P schedule-specific. A peer STA that is a member of the P2P schedule may use the corresponding TXOP for P2P transmission or infrastructure transmission (if the trigger frame allows both).

If a peer STA that is a member of the P2P schedule does not intend to be available during the P2P SP (e.g., for infrastructure communications), it may indicate its unavailability during the P2P SP following the baseline procedure. This can be useful for going off-channel P2P schedule.

According to one embodiment, a P2P scheduling STA (or any STA that is a member of the P2P schedule) may share the P2P schedule information—along with the AID list, MAC address list, or other identifiers of the member STAs—with the AP and indicate that the STAs that are members of the P2P schedule would not be available for infrastructure communications (i.e., UL or DL communications with the AP) during the P2P SPs corresponding to the P2P schedule. An AP that receives such information would not allocate resources for infrastructure communications to any STAs that are members of the P2P schedule during the P2P SPs.

According to one embodiment, a P2P scheduling STA (or any STA that is a member of the P2P schedule) may share the P2P schedule information by including the corresponding schedule information in a P2P Schedule Info frame. For example, the P2P Schedule Info frame may contain a TWT element containing a TWT parameter corresponding to the P2P schedule. The P2P Schedule Info frame may also contain a mode indication. For example, “Mode-1” can indicate that the P2P scheduling STA is seeking assistance from the AP to allocate a TXOP for P2P transmissions during the P2P SPs (for example, multiuser request-to-send (MU-RTS) TXS mode 2 trigger frame). “Mode-2” can indicate that the P2P scheduling STA is informing the AP about the unavailability of one or more STAs that are members of the P2P schedule for infrastructure communications with the AP during the P2P SPs corresponding to the P2P schedule so that the AP does not allocate infrastructure resources to the member STAs during those P2P SPs.

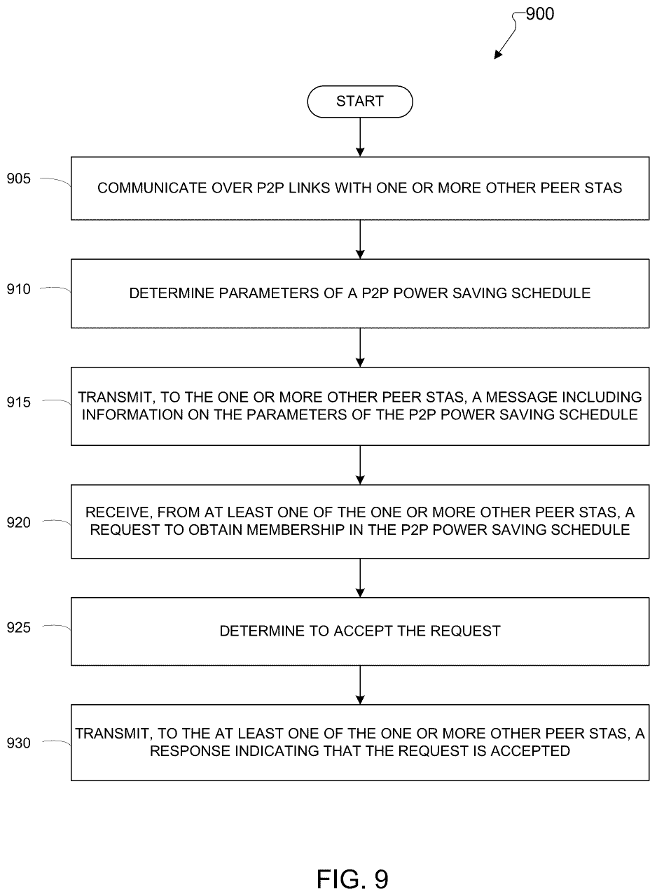

FIG. 9 illustrates an example process 900 for facilitating establishment of a common power saving schedule for multiple P2P devices in a WLAN according to various embodiments of the present disclosure. The process 900 of FIG. 9 is discussed as being performed by a peer STA, and it is understood that this could be an AP STA or a non-AP STA, and that other peer STAs perform a corresponding process. Additionally, for convenience the process of FIG. 9 is discussed as being performed by a WI-FI STA, however, it is understood that any suitable wireless communication device could perform this process.

Referring to FIG. 9, at step 905 a first peer STA communicates over P2P links with one or more other peer STAs. The P2P link may be, for example, one of a TDLS link, a WI-FI AWARE NAN link, or a WI-FI DIRECT link.

At step 910, the first peer STA determines parameters of a P2P power saving schedule. The parameters of the P2P power saving schedule may include, for example, parameters for a P2P SP during which P2P communications are allowed according to the P2P power saving schedule. In some embodiments, prior to step 910 the first peer STA participates in a distributed algorithm along with the one or more other peer STAs to determine whether the first peer STA or one of the one or more other peer STAs determines the parameters of the P2P power saving schedule.

Next, the first peer STA transmits, to the one or more other peer STAs, a message including information on the parameters of the P2P power saving schedule (step 915).

The first peer STA then receives, from at least one of the one or more other peer STAs, a request to obtain membership in the P2P power saving schedule (step 920). The first peer STA determines to accept the request at step 925 and transmits, to the at least one of the one or more other peer STAs, a response indicating that the request is accepted at step 930.

In some embodiments, the first peer STA remains in an active state during P2P SPs of the P2P power saving schedule, and in some embodiments, the member STAs of the P2P power saving schedule remain in an active state during P2P SPs of the P2P power saving schedule. P2P communications between the first peer STA and the member STAs of the P2P power saving schedule are allowed during P2P SPs of the P2P power saving schedule. In some embodiments, there is a P2P link between formed between at least two of the member STAs of the P2P power saving schedule, and P2P communications between the at least two member STAs are allowed during P2P SPs of the P2P power saving schedule.

In some embodiments, the first peer STA is a non-AP STA, the one or more other peer STAs are non-AP STAs, and the first peer STA and the one or more other peer STAs are associated with an AP STA. In such embodiments, one of the first peer STA or the one or more other peer STAs transmits, to the AP STA, a message including information on the parameters of the P2P power saving schedule and information identifying member STAs of the P2P power saving schedule.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A first peer station device (STA) comprising:
a transceiver configured to communicate over peer-to-peer (P2P) links with one or more other peer STAs; and
a processor operably connected to the transceiver and configured to determine parameters of a P2P power saving schedule,
wherein the transceiver is further configured to transmit, to the one or more other peer STAs, a message including information on the parameters of the P2P power saving schedule.

2. The first peer STA of claim 1, wherein the parameters of the P2P power saving schedule include parameters for a P2P service period (SP) during which P2P communications are allowed according to the P2P power saving schedule.

3. The first peer STA of claim 1, wherein the first peer STA remains in an active state during P2P SPs of the P2P power saving schedule.

4. The first peer STA of claim 1, wherein:
the one or more other peer STAs are member STAs of the P2P power saving schedule, and
the member STAs of the P2P power saving schedule remain in an active state during P2P SPs of the P2P power saving schedule.

5. The first peer STA of claim 1, wherein:
the transceiver is further configured to receive, from at least one of the one or more other peer STAs, a request to obtain membership in the P2P power saving schedule,
the processor is further configured determine to accept the request, and
the transceiver is further configured to transmit, to the at least one of the one or more other peer STAs, a response indicating that the request is accepted.

6. The first peer STA of claim 1, wherein:
the one or more other peer STAs are member STAs of the P2P power saving schedule, and
P2P communications between the first peer STA and the member STAs of the P2P power saving schedule are allowed during P2P SPs of the P2P power saving schedule.

7. The first peer STA of claim 1, wherein:
the one or more other peer STAs are member STAs of the P2P power saving schedule,
there is a P2P link between formed between at least two of the member STAs of the P2P power saving schedule, and
P2P communications between the at least two member STAs are allowed during P2P SPs of the P2P power saving schedule.

8. The first peer STA of claim 1, wherein:
the processor is further configured to participate in a distributed algorithm to determine whether the first peer STA or one of the one or more other peer STAs determines the parameters of the P2P power saving schedule, and
the one or more other peer STAs also participate in the distributed algorithm.

9. The first peer STA of claim 1, wherein:
the first peer STA is a non-access point (AP) STA,
the one or more other peer STAs are non-AP STAs,
the first peer STA and the one or more other peer STAs are associated with an AP STA, and
one of the first peer STA or the one or more other peer STAs transmits, to the AP STA, a message including information on the parameters of the P2P power saving schedule and information identifying member STAs of the P2P power saving schedule.

10. The first peer STA of claim 1, wherein the P2P link is one of a tunneled direct link setup (TDLS) link, a WI-FI AWARE neighbor awareness networking (NAN) link, or a WI-FI DIRECT link.

11. A method performed by a first peer station device (STA), the method comprising:
communicating over peer-to-peer (P2P) links with one or more other peer STAs;
determining parameters of a P2P power saving schedule; and
transmitting, to the one or more other peer STAs, a message including information on the parameters of the P2P power saving schedule.

12. The method of claim 11, wherein the parameters of the P2P power saving schedule include parameters for a P2P service period (SP) during which P2P communications are allowed according to the P2P power saving schedule.

13. The method of claim 11, wherein the first peer STA remains in an active state during P2P SPs of the P2P power saving schedule.

14. The method of claim 11, wherein:
the one or more other peer STAs are member STAs of the P2P power saving schedule, and
the member STAs of the P2P power saving schedule remain in an active state during P2P SPs of the P2P power saving schedule.

15. The method of claim 11, further comprising:
receiving, from at least one of the one or more other peer STAs, a request to obtain membership in the P2P power saving schedule;
determining to accept the request; and
transmitting, to the at least one of the one or more other peer STAs, a response indicating that the request is accepted.

16. The method of claim 11, wherein:
the one or more other peer STAs are member STAs of the P2P power saving schedule, and
P2P communications between the first peer STA and the member STAs of the P2P power saving schedule are allowed during P2P SPs of the P2P power saving schedule.

17. The method of claim 11, wherein:
the one or more other peer STAs are member STAs of the P2P power saving schedule,
there is a P2P link between formed between at least two of the member STAs of the P2P power saving schedule, and
P2P communications between the at least two member STAs are allowed during P2P SPs of the P2P power saving schedule.

18. The method of claim 11, further comprising:
participating in a distributed algorithm to determine whether the first peer STA or one of the one or more other peer STAs determines the parameters of the P2P power saving schedule,
wherein the one or more other peer STAs also participate in the distributed algorithm.

19. The method of claim 11, wherein:
the first peer STA is a non-access point (AP) STA,
the one or more other peer STAs are non-AP STAs,
the first peer STA and the one or more other peer STAs are associated with an AP STA, and
one of the first peer STA or the one or more other peer STAs transmits, to the AP STA, a message including information on the parameters of the P2P power saving schedule and information identifying member STAs of the P2P power saving schedule.

20. The method of claim 11, wherein the P2P link is one of a tunneled direct link setup (TDLS) link, a WI-FI AWARE neighbor awareness networking (NAN) link, or a WI-FI DIRECT link.
